(19) United States
(12) Patent Application Publication
(10) Pub. No.: US 2023/0185652 A1
(43) Pub. Date: Jun. 15, 2023

(54) REAL-TIME SELF-ADAPTIVE TUNING AND CONTROL OF A DEVICE USING MACHINE LEARNING

(71) Applicant: ADAPDIX CORPORATION, Pleasanton, CA (US)

(72) Inventors: Steven HAUSER, Lancaster, PA (US); Anthony HILL, Danville, CA (US)

(73) Assignee: ADAPDIX CORPORATION, Pleasanton, CA (US)

(21) Appl. No.: 17/548,521

(22) Filed: Dec. 11, 2021

(51) Int. Cl. G06F 11/07; G06N 20/00; G06T 5/50

(52) U.S. Cl. CPC G06F 11/079; G06N 20/00; G06T 5/50; G06T 2207/20221

(57) ABSTRACT

Embodiments for real-time self-adaptive tuning and control of a device using machine learning are disclosed. For example, a method includes receiving real-time data for a plurality of parameters of the device from a plurality of sources associated with the device and selecting at least one machine learning model from a plurality of machine learning models based on the received real-time data. The method further includes predicting at least one control set point based on the at least one selected machine learning model. The at least one predicted control set point of the device is adjusted for the real-time self-adaptive tuning and control of the device.

### FIELD OF THE INVENTION

The embodiments discussed in the present disclosure are generally related to low latency adaptive tuning and control of a device. In particular, the embodiments discussed are related to real-time self-adaptive low latency adaptive tuning and control of a device using machine learning.

### BACKGROUND OF THE INVENTION

Calibration of a device and its sensors is essential for ensuring accurate measurements, product quality, safety, profitability, compliance with regulations, return on investment, reduction of production errors and recalls, and extending the device’s life. Device tuning is the process of adjusting parameters of the device so that it works correctly. Calibration and tuning of an equipment used for semiconductor fabrication, such as pick and place equipment or die attach equipment, is even more important, since such equipment involve precision measurements in the nanometer and micrometer range. All mechanical parts wear and electronic components drift over time, so a measuring instrument may not measure precisely to its specifications forever. Therefore, the device should be calibrated and re-tuned regularly to ensure that it is operating properly. Tuning and calibration of the device require manual intervention, which sometimes requires stopping the device. Manual intervention on the device to eliminate an unsafe working condition for the operator, the device, or a part of the device normally has a lag time and might be dangerous. There is a need in the art for devices to self-stop or slow down in real-time when a dangerous condition is observed or predicted. To ensure optimal performance, the device needs to self-calibrate and self-tune continuously.

It has been traditional for an equipment operator to receive an alert or notification of a device part misbehavior and optionally to be notified of its criticality level. Upon receiving an alert, there is a tendency to address an anomaly immediately or during the next scheduled maintenance window. Many times, the anomaly or the device part misbehavior is not significant enough to stop operations. Accordingly, the art has a need to determine if it is safe enough to continue operations based on the anomaly.

There is a tendency to manufacture/produce as fast as possible and maximize Units Per Hour (UPH) production during manufacturing. In practice, however, as the UPH rises, yield, defined as the proportion of non-defective items versus the number of manufactured items, falls. This problem is further exacerbated by the fact that similar types of devices are tuned to the lowest yield producing setting, as they are tuned to operate as quickly as possible, regardless of the state and environment of the device. In the art, it is important to achieve the best UPH from the device without affecting the yield. In addition, the device needs to be tuned individually by taking all relevant factors into account.

In view of at least the above-mentioned issues, there is a need in the art for improved systems and methods for real-time self-adaptive tuning and control of a device.

### SUMMARY OF THE INVENTION

Embodiments for real-time self-adaptive tuning and control of a device using machine learning are disclosed that address at least some of the above-mentioned challenges and issues.

In accordance with the embodiments of this disclosure, a method is disclosed. The method includes receiving real-time data for a plurality of parameters of the device from a plurality of sources associated with the device and selecting at least one machine learning model from a plurality of machine learning models based on the received real-time data. The method further includes predicting at least one control set point based on the at least one selected machine learning model. The at least one predicted control set point of the device is adjusted for the real-time self-adaptive tuning and control of the device.

In accordance with the embodiments of this disclosure, a system for real-time self-adaptive tuning and control of a device using machine learning is disclosed. The system comprises a computing device configured to receive real-time data for a plurality of parameters of the device from a plurality of sources associated with the device and select at least one machine learning model from a plurality of machine learning models based on the received real-time data. The computing device of the system according to the present embodiment of the disclosure is further configured to predict at least one control set point based on the at least one selected machine learning model. Then, the at least one predicted control set point of the device is adjusted for the real-time self-adaptive tuning and control of the device.

### BRIEF DESCRIPTION OF THE DRAWINGS

Further advantages of the invention will become apparent by reference to the detailed description of preferred embodiments when considered in conjunction with the drawings:

FIG. 1 illustrates an example network topology for implementing disclosed embodiments of a secure communication network in accordance with an embodiment of the disclosure.

FIG. 2 illustrates an example machine learning based real-time self-adaptive tuning and control system at an edge location of the device in accordance with the embodiments of the present disclosure.

FIG. 3 illustrates another example machine learning based real-time self-adaptive tuning and control system at an edge location of the device in accordance with the embodiments of the present disclosure.

FIG. 4 illustrates a schematic illustration of a real-time machine learning based system for providing adaptive control of the device based on disparate input sources in accordance with an embodiment of the disclosure.

FIG. 5 illustrates a flowchart for real-time self-adaptive tuning and control of a device using machine learning in accordance with an embodiment of the disclosure.

FIG. 6 illustrates a flowchart for training a machine learning model for real-time self-adaptive tuning and control of a device using the machine learning model in accordance with an embodiment of the disclosure.

### DETAILED DESCRIPTION

The following detailed description is presented to enable any person skilled in the art to make and use the invention. For purposes of explanation, specific details are set forth to provide a thorough understanding of the present invention. However, it will be apparent to one skilled in the art that these specific details are not required to practice the invention. Descriptions of specific applications are provided only as representative examples. Various modifications to the preferred embodiments will be readily apparent to one skilled in the art, and the general principles defined herein may be applied to other embodiments and applications without departing from the scope of the invention. The present invention is not intended to be limited to the embodiments shown but is to be accorded the widest possible scope consistent with the principles and features disclosed herein.

The disclosed solution/architecture provides a mechanism for self-adaptive tuning and control of a device in real-time using machine learning models running on a computer. The mechanism may self-calibrate and self-tune the device continuously to get most optimal performance from the device. Machine learning models running on the computer may get real-time sensor data and context data and determine the most optimal calibration parameters. The determined calibration parameters may be compared to see if there is any drift and may be validated for safety, threshold, and improvements. The determined calibration parameters, if drifted, are then fed back in real-time over a communication network to the computer. The computer may do its own validation and then set the determined calibration parameters on the device. The set values of the determined calibration parameters are then optionally feedback to the machine learning model running on the computer to validate the change as well as improvement, or to further re-calibrate and re-tune.

Certain terms and phrases have been used throughout the disclosure and will have the following meanings in the context of the ongoing disclosure.

A “network” may refer to a series of nodes or network elements that are interconnected via communication paths. The network may include any number of software and/or hardware elements coupled to each other to establish the communication paths and route data/traffic via the established communication paths. In accordance with the embodiments of the present disclosure, the network may include, but are not limited to, the Internet, a local area network (LAN), a wide area network (WAN), and/or a wireless network. Further, in accordance with the embodiments of the present disclosure, the network may comprise, but is not limited to, copper transmission cables, optical transmission fibers, wireless transmission, routers, firewalls, switches, gateway computers, and/or edge servers.

A “device” may refer to an apparatus using electrical, mechanical, thermal, etc., power and having several parts, each with a definite function and together performing a particular task. The device can be any equipment such as a robotic equipment, pick and place equipment, die attach equipment, garbage sorting equipment, automated precision die bonder, optical inspection equipment, compute instances in a data center, etc.

The term “device” in some embodiments, may be referred to as equipment or machine without departing from the scope of the ongoing description.

The term “sensors” may refer to a device, module, machine, or subsystem whose purpose is to detect events or changes in its environment, and send the information to other electronics, frequently a computer processor. As such, a sensor may be a device that measures physical input from its environment and converts it into data that may be interpreted by either a human or a machine. Most sensors are electronic and convert the physical input from its environment into electronic data for further interpretation. In accordance with the embodiments of the present disclosure, sensors may be coupled to, or mounted on to the device, and may provide real-time measurements of the conditions of the device during its operation.

The device may have “internal sensors,” which are physically attached to the device and help with proper functioning of the device. Internal sensors may be used for measuring motion, pressure, axis position, acceleration, rotation, tilt, temperature, vibrations, humidity, etc. These internal sensors may be connected in a wired or wireless way to device’s Data Acquisition System (DAQ) or its Programmable Logic Controller (PLC) or any other data acquisition or control system.

Measurement of conditions on the device may be supplemented with “external sensors.” These external sensors, such as Bosch XDK sensor, etc., may measure motion, vibrations, acceleration, temperature, humidity, etc., and may provide sensing of additional parameters that may be missed by the internal sensors.

The term “Data Acquisition System (DAQ)” may be defined as a system that samples signals from internal sensors/external sensors and converts them into digital form that may be manipulated by a computer and software. DAQ system takes signals from the internal sensors/external sensors, condition the signals, do the analog to digital conversion, and make the digital signals available for further use.

The term “Programmable Logic Controller (PLC)” or programmable controller is an industrial digital computer that has been ruggedized and adapted for the control of manufacturing processes, such as assembly lines, robotic devices, or any activity that requires high reliability, ease of programming, and process fault diagnosis. PLCs may range from small modular devices with tens of inputs and outputs (I/O), in a housing integral with the processor, to large rack-mounted modular devices with thousands of I/O, and which may often be networked to other PLC and Supervisory control and data acquisition (SCADA) systems.

A “computer system” may be described in the general context of computer system executable instructions, such as program modules, being executed by a computer system in the embodiments of the present disclosure. Generally, program modules may include routines, programs, objects, components, logic, data structures, and so on that perform particular tasks or implement particular abstract data types. The components of computer system may include, but are not limited to, one or more processors or processing units, a system memory, and a bus that couples various system components including the system memory to the one or more processors or processing units.

A “processor” may include a module that performs the methods described in accordance with the embodiments of the present disclosure. The module of the processor may be programmed into the integrated circuits of the processor, or loaded in memory, storage device, or network, or combinations thereof.

The term “actuator” may be defined as a component of a device that may be responsible for moving and controlling a mechanism or system of the device, for example by opening a valve. As such, an actuator may be a part of a device or machine that helps the device or the machine to achieve physical movements by converting energy, often electrical, air, or hydraulic, into mechanical force. Simply put, an actuator may be defined as a component in any machine that enables movement and the motion it produces may be either rotary/linear or any other form of movement.

“User Datagram Protocol (UDP)” or sometimes referred to as UDP/IP may be defined as a communications protocol that facilitates exchange of messages between computing devices in a network that uses the Internet Protocol (IP). UDP divides messages into packets, called datagrams, which may then be forwarded by the computing devices in the network to a destination application/server. The computing devices may, for example, be switches, routers, security gateways etc.

“Modbus” is a data communications protocol for use with programmable logic controllers (PLCs). The Modbus protocol uses character serial communication lines, Ethernet, or the Internet protocol suite, as a transport layer.

“Open Platform Communications (OPCs)” is an interoperability standard for secure and reliable exchange of data in the industrial automation space and in other industries. It is platform independent and ensures seamless flow of information among devices from multiple vendors.

The “SECS (SEMI Equipment Communications Standard)/GEM (Generic Equipment Model)” standards are a semiconductor’s equipment interface protocol for equipment-to-host data communications. In an automated fabrication, the interface may start and stop equipment processing, collect measurement data, change variables, and select recipes for products.

“Profinet” may be defined as an industry technical standard for data communication over Industrial Ethernet. Profinet is designed for collecting data from, and controlling equipment in industrial systems, with a particular strength in delivering data under tight time constraints.

The term “anomaly detection” may be defined as the identification of rare items, events, or observations which raise suspicions by differing significantly from the baseline of the data associated with the device. Anomaly detection may be used to detect and alert about an abnormal event in the device.

The term “predictive analysis” may encompass a variety of statistical techniques from data mining, predictive modelling, and machine learning, which analyze current and historical facts to make predictions about future or otherwise unknown events. Predictive Analysis may be used to predict failure well in advance. Predictive analytics is an area of statistics that deals with extracting information from data and using it to predict trends and behavior patterns. Often the unknown event of interest is in the future, but predictive analytics can be applied to any type of unknown events whether it be in the past, present, or future.

The term “machine learning” may refer to as a study of computer algorithms that may improve automatically through experience and by the use of data. Machine learning algorithms build a model based on sample data, known as “training data,” in order to make predictions or decisions without being explicitly programmed to do so. Machine learning algorithms are used in a wide variety of applications, such as in medicine, email filtering, speech recognition, and computer vision, where it is difficult or unfeasible to develop conventional algorithms to perform the needed tasks.

In machine learning, a common task is the study and construction of algorithms that can learn from and make predictions on data. Such algorithms function by making data-driven predictions or decisions, through building a mathematical model from input data. These input data used to build the model which are usually divided in multiple data sets. In particular, three data sets are commonly used in various stages of the creation of the model: training, validation, and test sets.

The model is initially fit on a “training data set,” which is a set of examples used to fit the parameters of the model. The model is trained on the training data set using a supervised learning method. The model is run with the training data set and produces a result, which is then compared with a target, for each input vector in the training data set. Based on the result of the comparison and the specific learning algorithm being used, the parameters of the model are adjusted. The model fitting can include both variable selection and parameter estimation.

Successively, the fitted model is used to predict the responses for the observations in a second data set called the “validation data set.” The validation data set provides an unbiased evaluation of a model fit on the training data set while tuning the model’s hyperparameters. Finally, the “test data set” is a data set used to provide an unbiased evaluation of a final model fit on the training data set.

The term “real-time data” may be defined as data that is not kept or stored but is passed along to the end user as quickly as it is gathered. The term “input sources” may be defined as any equipment based internal or external input sources that produce signals and measurements in real-time.

In accordance with the embodiments of this disclosure a system for real-time self-adaptive tuning and control of a device using machine learning is disclosed. The system comprises a computing device configured to receive real-time data for a plurality of parameters of the device from a plurality of sources associated with the device and select at least one machine learning model from a plurality of machine learning models based on the received real-time data. The computing device of the system according to the present embodiment of the disclosure is further configured to predict at least one control set point based on the at least one selected machine learning model. Then, the at least one predicted control set point of the device is adjusted for the real-time self-adaptive tuning and control of the device.

In accordance with the embodiments of this disclosure, the computing device in the system described by the embodiment of this disclosure is configured to collect training data for at least one of the plurality of parameters of the device from at least one of the plurality of sources associated with the device.

In accordance with the embodiments of this disclosure, the system further comprises a remote computing device located remotely from the device and connected to the device via a communication network. The remote computing device is configured to train the at least one machine learning model from the plurality of machine learning models based on the collected training data.

In accordance with the embodiments of this disclosure, the real-time data comprises one or more of sensor data from at least one sensor located inside the device, sensor data from at least one sensor located outside the device, context data, changes in dynamics of the device, and environmental data surrounding the device.

Further, in accordance with the embodiments of this disclosure, the context data comprises one or more of functioning state, device functioning errors, inventory status, device parts log, wear and tear status, material details, preventive maintenance schedule, order status, delivery schedules, degraded device state, and operator parameters.

In accordance with the embodiments of this disclosure, the remote computing device is further configured to train the at least one machine learning model at an edge of the device, wherein the edge of the device corresponds to one or more of: close to a source of the plurality of sources of the device, a cloud, and a remote computer.

Further, in accordance with the embodiments of this disclosure, the computing device is further configured to correlate and stitch together one or more of sensor data, from one or more of sensor located inside the device, sensor located outside the device, context data, changes in dynamics of the device, and environmental data surrounding the device, to form context-aware data.

Furthermore, in accordance with the embodiments of this disclosure, the computing device is further configured to select the at least one machine learning model based at least on the context-aware data.

The various embodiments throughout the disclosure will be explained in more detail with reference to figures.

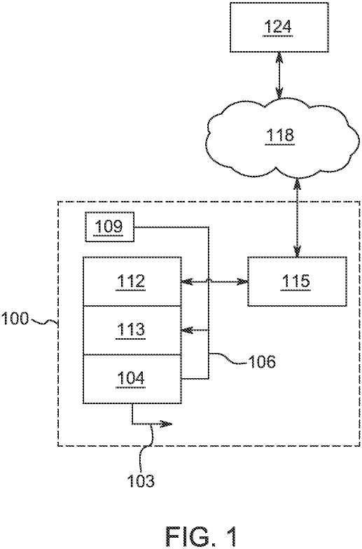

FIG. 1 illustrates an example machine learning based real-time self-adaptive tuning and control system at an edge location in accordance with the embodiments of the present disclosure. FIG. 1 depicts an edge device 100, which may be an edge location of a device in accordance with the embodiments of the present disclosure. The term “device edge” may be replaced by the term “equipment edge” without departing from the scope of the present disclosure. Edge device 100 is defined as a location that is close to a source of data generation such that response times are ultra-low (milliseconds), and bandwidth and cost of handling data is optimal.

Further, FIG. 1 depicts a device 103 that uses electrical, mechanical, thermal, etc., power and has several parts, each with a definite function and together performing a particular task. Device 103 may be any equipment such as a robotic equipment, pick and place equipment, die attach equipment, garbage sorting equipment, automated precision die bonder, optical inspection equipment, compute instances in a data center, etc. Device 103 may have internal sensors 104, which are physically attached to the device 103 and help with proper functioning of the device 103. Internal sensors 104 may be coupled to, or mounted on to the device 103, and may provide real-time measurements of the conditions of the device 103 during its operation. Internal sensors 104 may be used for measuring motion, pressure, axis position, acceleration, rotation, tilt, temperature, vibrations, humidity, etc. These internal sensors 104 may be connected in a wired or wireless way to device’s Data Acquisition System (DAQ) or its Programmable Logic Controller (PLC) or any other data acquisition or control system.

Measurement of conditions on the device 103 may be supplemented with external sensors 109. These external sensors 109, such as Bosch XDK sensor, etc., measure motion, vibrations, acceleration, temperature, humidity, etc., and may provide sensing of additional parameters that may be missed by the internal sensors 104.

In accordance with the embodiments of the present disclosure, the device 103 also contains an internal processing system 112 such as a computer system. The computer system is only one example of a suitable processing system 112 and is not intended to suggest any limitation on to the scope of use or functionality of embodiments of the methodology described herein. The processing system 112 shown in FIG. 1 may be operational with numerous other general purpose or special purpose computing system environments or configurations. Examples of well-known computing systems, environments, and/or configurations that may be suitable for use with the processing system 112 shown in FIG. 1 may include, but are not limited to, personal computer systems, server computer systems, thin clients, thick clients, multiprocessor systems, etc.

In accordance with an embodiment of the present disclosure, the processing system 112 acts as a primary controller such as Process Control Master (PCM), and features an intuitive machine/process interface that includes all referencing, positioning, handling, and system control and management. The processing system 112 also features access to all internal sensor data through Data Acquisition System (DAQ), process and machine logs, equipment operational performance data, and system state data, such as, if the device 103 is running or under some type of maintenance, etc. The processing system 112 also features a controller interface to actuate parameters through respective actuators on the device 103. Further, the processing system 112 may be coupled to a database 113 on a storage device. This database 113 may store sensor data, test data, device performance data, logs, configuration, etc.

FIG. 1 depicts a separate external computer or processing system 115 installed close to the device 103 and includes one or more processors or processing units, a system memory, and a bus that couples various system components including system memory to the processor. This external computer or processing system 115 comprises executable instructions for data access from disparate data sources, external sensors, process control master, databases, external data sources, etc., via any communication protocol, such as User Datagram Protocol (UDP), MODBUS, SECS/GEM, Profinet, or any other protocol, and via any communication network 106, such as ethernet, Wi-Fi, Universal Serial Bus (USB), ZIGBEE, cellular or 5G connectivity, etc. This external computer or processing system 115 also comprises executable instructions for running trained machine learning models against real-time disparate data.

Computer readable program instructions may be downloaded to the processing system 112 from a computer readable storage medium or to the external computer or processing system 115 via a network, for example, the Internet, a local area network, a wide area network, and/or a wireless network. The network may comprise copper transmission cables, optical transmission fibers, wireless transmission, routers, firewalls, switches, gateway computers, and/or edge servers. A network adapter card or network interface in each processing system 112 or processing system 115 receives computer readable program instructions from the network and forwards the computer readable program instructions for storage in a computer readable storage medium within the respective processing system 112 or processing system 115.

In accordance with an embodiment of the present disclosure, the external computer or processing system 115 may execute machine learning models using techniques such as, but not limited to, Dynamic Time Warping (DTW), Frequency Domain Analysis, Time Domain Analysis, Deep Learning, Fuzzy Analysis, Artificial Neural Network Analysis, Xgboost, Random Forest, Support Vector Machine (SVM) Analysis, etc., for anomaly detection, and prediction and adaptive control of the actuator.

FIG. 1 further depicts that the external computer or processing system 115 presents training data, features, and relevant contextual and environment variables to a remote computer or processing system 124 for training of a machine learning model. Communication between external computer or processing system 115 and remote computer or processing system 124 may be via a communication network 118 such as local area network (LAN), a general wide area network (WAN), and/or a public network (e.g., the Internet, Wi-Fi, 5G) via network adapter etc. Remote computer 124 may be located on an on-prem location, remote to the edge site, or may be in a cloud. A skilled person in the art may understand that although not shown, other hardware and/or software components may be used in conjunction with the remote computer 124. Examples include, but are not limited to a microcode, device drivers, redundant processing units, external disk drive arrays, Redundant Array of Independent Disks (RAIDs) systems, tape drives, and data archival storage systems, etc.

In an embodiment of the present disclosure, sensor data from the internal sensors 104 such as axis power consumption, accelerometer readings, axis position data from a silicon photonic optical alignment device is accessed through a Programmable Logic Controller (PLC) on the device 103, using, for example, TwinCAT protocol, by the primary controller on the processing system 112 of the device 103. The primary controller also captures other context data in real-time in its internal computer storage/database 113. The context data captured may be, but not limited to, process logs, motion settings, position errors, axis movements, module test results, yield, jerk settings etc. Said sensor data from the internal sensors 104 and context data may be requested by the external computer 115 at an ultra-low frequency, for example, 25 ms, over UDP communication network 106 using a UDP Input/Output (IO) manager. External computer 115 correlates said data together on time and other labels, such as module ID, etc. External computer 115 presents this data to its runtime engine in real-time as it comes into its internal memory buffer. External computer 115 runtime engine runs a pretrained machine learning algorithm on this data set with intent to decrease position errors during movement, the algorithm ensures motion error is not so large that it affects the yield and tries to maintain motion errors during large movements which creates excess vibrations. External computer 115 uses the needed sensor and context data from internal memory, so that there is no lag or time wasted in making a database or any other TCP connection. This is critical for ultra-low latency inferencing. The output of the algorithm is a jerk setting for the motion. This output may also be stored in memory for ultra-low latency needs. Jerk is defined as sharp sudden movement; it is a derivative of acceleration with respect to time. These jerk settings are validated to be within accepted bounds, and also validated to create a positive impact on the cycle times. These predicted jerk settings are sent from the external computer 115 over the UDP communication network 106 to the primary controller on the internal computer 112 of the device 103. The jerk settings are communicated, over, for example TwinCAT protocol, to proper PLC and are actuated on the PLC. Optimized jerk settings enable to smooth out the vibrations of the motion on the device 103 and allow the device 103 to run as fast as possible (maximize UPH) while maintaining optimal yield. Resultant jerk settings are reconveyed to the external computer 115 over the UDP communication network 106 by the primary controller on the internal computer 112 to readjust, if needed. All this happens in ultra-low frequency of around 5-30 ms. In one embodiment, as soon as the data request is triggered by the external compute 115 till inference on the jerk setting is sent back to, actuation happens in 5 to 25 ms. Jerk setting adaptive control may reduce cycle time, increasing the UPH while keeping yield intact. This also enables reduced vibration and enables less wear and tear on device parts. Self-tuning and self-adaptive correction of the device 103 is also enabled. It also enables localized tuning of the device 103 as the algorithm and settings may be specific for each device while considering environmental changes, change in dynamics of individual devices, wear and tear and life of the parts, as well as any structural defects in the individual devices. The jerk self-tuning in an embodiment of the present disclosure may be regarded as adaptable if the process behavior changes due to ageing, drift, wear, etc., and the machine learning model may account for the changes and come up with most optimal jerk settings based on the complete contextual and environmental information.

A specific example of jerk self-tuning in accordance with an embodiment of the present disclosure may be an algorithm designed to look at motion information - absolute position and position errors - across 3 independent axes, as well as optical power through a focusing lens. As the focusing lens is moved, the algorithm collects this data and returns an optimum jerk (derivative of acceleration) based on individual axis position errors relative to which axis/combination of axis are moving at any given time, as well as how noisy the optical power data is during the movements.

In accordance with one embodiment, all disparate data sources such as sensor data of the internal sensors 104, such as motion, axis position, acceleration, rotation, tilt, temperature, vibrations, humidity, etc.; sensor data of the external sensors 109 that supplements the device sensor data and is collected by installing external sensors 109 on the device 103; image data such as component cracks, placement, operator action, etc.; context data from internal storage device/database 113, such as device functioning state, errors, testing data, parts inventory, age and wear on the parts, material details, preventive maintenance schedule, orders and delivery schedules, operator capabilities, and other such data that forms the background information that provides a broader understanding of an event, person, or component; environmental changes surrounding the device 103, such as a fan being on near the device 103, device 103 being close to a heat source, device 103 being close to a vibration source, humidity, etc.; changes in dynamics of the device 103, age and wear of device parts; structural damages, and changes in material, are taken into account to train machine learning models at remote computer 124, using techniques such as, Dynamic Time Warping (DTW), Frequency Domain Analysis, Time Domain Analysis, Deep Learning, Fuzzy Analysis, Artificial Neural Network Analysis, Xgboost, Random Forest, Support Vector Machine (SVM) Analysis, etc.

In an embodiment of FIG. 1, the device 103 is used in manufacturing and has internal sensors 104 and external sensors 109 that sense and capture real-time data. The data store or the database 113 and device’s internal computer or processing system 112 capture context data such as part serial number, equipment configuration, machine state, machine, and process logs, etc. The primary controller on device’s internal computer 112 may also communicate and capture data from its internal sensors 104 via any suitable communication network. A separate external computer or processing system 115 communicates with the primary controller on device’s internal computer 112 via a suitable communication network 106, such as UDP. In accordance with the embodiments of the present disclosure, this communication between the external computer 115 and the primary controller on the internal computer 112 may be two ways, thus enabling data access as well as sending back actuation commands. External computer 115 may also communicate with external sensors 109 via a suitable communication network 106, such as USB. External computer 115 may also communicate with the internal computer 112 via a suitable communication network 106, such as UDP to acquire logs and other contextual information in real-time.

In accordance with an embodiment of the present disclosure, external computer 115 provides and transfers training data to a machine learning training platform on the remote computer 124 via communication network 118 such as local area network (LAN). Remote computer 124 chooses appropriate machine learning algorithm and trains the machine learning model. Computer instructions representing the trained model are then deployed on the external computer 115 for local, at the edge inferencing. Real-time internal sensor data 104, external sensor data 109, context and logs data, as well as external environmental data is presented at time-triggered intervals or as the data comes into the machine learning runtime on the external computer 115. Real-time inferencing is done using the proper trained machine learning model running on the external computer 115, and results of the inferencing are used for alerts, or displaying normal behavior, or predicting an anomaly, or the results are validated for safe operations and improvements and used to actuate and set certain parameters on the device 103 via two-way communication 106 with the primary controller on the internal computer 112. The primary controller on the internal computer 112 then actuates proper actuators on the device and measures the Overall Equipment Effectiveness (OEE) improvements. The new values provided by the sensors are then feedback to the external computer 115 for validation of improvements, or further refinement of the parameter, which completes the control loop.

So, in accordance with the embodiments of the present disclosure, sensor data (from the internal sensors 104 and external sensors 109), context data, environmental changes surrounding the device 103, changes in dynamics of the device 103, age and wear of device parts, structural damages, and changes in material, are all considered in real-time by the machine learning models running on the external computer 115 to adjust operation parameters of the device 103 to improve the OEE.

In accordance with an embodiment of the present disclosure machine learning models running on the external computer 115 and the adaptive control loop to activate the operation parameters after inference, are fed back in real-time over the communication network 106 to primary controller on the internal computer 112. The operation parameters are then actuated by the primary controller on the internal computer 112 using preferred protocol and the resulting sensor data from the internal sensors 104 and external sensors 109 is fed back through the communication network 106 to the external computer or processing system 115. The changed values of the operation parameters may be on target, in phase with an input signal, or out of phase with an input signal. The machine learning models running on the external computer 115 may then further be corrected to achieve the target state. When signal feedback from output is in phase with the input signal, the feedback adaptive control is called positive feedback adaptive control. When signal feedback from output is out of phase with the input signal, the feedback adaptive control is called negative feedback adaptive control.

In an embodiment of the present disclosure, the machine learning models running on the external computer 115 are trained to output estimated adaptive control parameters that are directly used in an adaptive controller (not shown) of the device 103, thereby enabling direct adaptive control. In another embodiment, the machine learning models running on the external computer 115 are trained to output estimated adaptive control parameters that are used to calculate other controller parameters in the adaptive controller of the device 103, thereby enabling indirect adaptive control. In yet another embodiment of the present disclosure, the machine learning models running on the external computer 115 are trained to output estimated adaptive control parameters. Both estimation of the controller parameters and direct modification of the controller parameters are used by the adaptive controller of the equipment 103, thereby enabling hybrid adaptive control.

In an embodiment of the present disclosure, adaptive control machine learning models running on the external computer 115 may be used to self-calibrate and self-tune the device 103 continuously to get most optimal performance from the device 103. Calibration of the device 103 and device’s internal sensors 104 is important to ensure accurate measurements, product quality, safety, profitability, complying with regulations, return on investment, reduction in production errors and recalls, and extending life of the device 103. In an embodiment of the present disclosure, the machine learning models running on the external computer 115 would get real-time sensor data and context data and determine the most optimal calibration parameters. The determined calibration parameters are compared to see if there is any drift, then these determined calibration parameters are validated for safety, threshold, and improvements. The determined calibration parameters, if drifted, are then fed back in real-time over the communication network 106 to the primary controller on the internal computer 112. The primary controller on the internal computer 112 may do its own validation and then set the determined calibration parameters on the device 103. The set values of the determined calibration parameters are then optionally feedback to the machine learning model running on the external computer 115 to validate the change as well as improvement, or to further re-calibrate and re-tune.

In accordance with the present disclosure, anomaly detection is the identification of rare items, events or observations which raise suspicions by differing significantly from the baseline of the data. Predictive Analysis encompasses a variety of statistical techniques from data mining, predictive modelling, and machine learning, which analyze current and historical facts to make predictions about future or otherwise unknown events. Anomaly detection can detect and alert about an abnormal event in the device 103, and Predictive Analysis can predict failure well in advance. However, these alerts and predictions still require manual intervention and a lag in fixing the issue resulting in yield reduction and/or part failures. The present disclosure uses the predictions and anomaly detection from machine learning models to do adaptive control in real-time and get the most out of the device 103.

In an embodiment of the present disclosure, manual intervention to act on an anomaly or part failure prediction analysis is automated by automatically adjusting the operation parameters with adaptive control to correct the anomaly, by self-maintaining the performance level of the device 103, and by providing detail root causes and Out of Control Action Plans (OCAPs) instructions to an operator. This helps to get the most out of the device 103 and saves operator time to determine the root cause and to come up with an action plan.

Further, in an embodiment of the present disclosure, adaptive control machine learning models running on the external computer 115 may take into account contextual information, such as real-time yield and sensor information, such as acceleration, motion errors, axis errors, jerk settings, etc., and try to self-accelerate the device 103 to get the best UPH from the device 103 without affecting the yield. The yield may be constantly monitored in real-time so any changes to operation parameters to speed up the device 103 that causes adversarial effect on yield may be caught at ultra-low latency and may be acted upon and thus speed of the device 103 may be brought back. This also enables custom auto tuning of the device 103 individually considering all the relevant factors. Thus, the embodiments of the present disclosure describe self-stopping or slowing down the device 103 in real-time on observing or predicting an unsafe working condition.

In an embodiment of the present disclosure, adaptive control machine learning models running on the external computer 115 may take into account contextual information about an operator or a part and stop or slow the device 103 to enable safe working condition. Auto intervention on the device 103 to eliminate an unsafe working condition for the operator, device 103 or part usually at ultra-low frequency may save lives and device parts.

In an embodiment of the present disclosure, when a device operator receives an alert or notification of anomaly of an equipment part misbehavior and optionally gets a criticality level for the alert, the tendency is to address the anomaly immediately or in the next scheduled maintenance window, affecting production time for the device 103. In many instances, the anomaly or the part misbehavior may not be critical enough to stop operations. The embodiments of the present disclosure use machine learning to operate in Fail Operational state or a degraded state and keep manufacturing parts, thus increasing the UPH. Fail Operational state is defined as safe to operate state even after a failure. In an embodiment of the present disclosure, sensor data (from the internal sensors 104 and the external sensors 109) and context data, such as device functioning state, errors, testing data, parts inventory, age and wear on the parts, material details, preventive maintenance schedule, orders and delivery schedules, history of the degraded state, operator capabilities and other such data that forms the background information that provides a broader understanding of an event, person, or component, is used by the machine learning models running on the external computer 115 to determine if despite of the error, the device 103 may operate in Fail Operational state. The machine learning model may be trained to operate in Fail Operational state when it is determined to be safe enough to continue operations in a Fail Operational state with necessary automatic tuning to account for the misbehaving part, where the system may continue to function after a failure. This assures Fail Passive behavior for the device 103, which means the system may not misbehave after a failure.

In accordance with an embodiment of the present disclosure, the anomaly detection is done by looking at historical data and identifying trends in the data that are undesirable. As an example, the data may consistently vary around some mean value, say 0, but if the mean starts to shift upward (resulting in a ramp away from 0 over time) a machine learning model may pick this up and flag the pattern as being an anomaly. This information can then be used as a basis for informing a user of a potential issue with the device 103.

In accordance with an embodiment of the present disclosure, machine learning model training may happen at the edge, close to the data source, in the cloud, or on any remote computer. In certain embodiments, the mathematical representations of the machine learning model training details are stored in memory close to the source of input data. Disparate relevant data streams are fed in memory to a machine learning runtime engine running on the external computer 115 close to the data source in order to get low latency inferencing. In an embodiment of the present disclosure, inferencing from the machine learning models may happen in real-time at the external computer 115 at an ultra-low frequency of 5 to 30 ms. Further, the inferences and results from the machine learning algorithms are validated for proper behavior and improvements are fed back to the internal computer 112 for actuation. The internal computer 112 actuates the desired parameters and results of the changes are fed to the run-time engine on the external computer 115 to validate improvements or do further changes, thereby achieving improvements in equipment uptime, UPH, yield, cost of operation, spare parts usage, cycle time improvements, and Overall Equipment Effectiveness (OEE) improvements.

In one embodiment, model training and retraining may be performed based on one or more device or manufacturing process optimization characteristics. Examples of optimization characteristics include, but are not limited to, reducing equipment downtime, increasing first pass and overall yield of manufacturing, increasing the Units Produced per hour, improving the availability of the device, improving unscheduled downtime, improving Mean Time Between Failure (MTBF), and improving Mean Time to Repair (MTTR) and other device or manufacturing process characteristics.

In accordance with another embodiment, edge inferencing at the external computer 115 from disparate input data sources (the internal sensors 104 and the external sensors 109) is done in real-time without a machine learning model and without any training of the model or with un-supervised training, based on simple rules or algorithms derived from experience of Subject Matter Experts (SMEs). The inferences are then feedback to a controller through the device’s internal computer 112 for actuating and tuning various parameters in the device 103. Without a machine learning model, this may be done for example based on a rules-based implementation. As such, the user may understand the device data well enough to build known alert rules/escalations/actions, and would leverage this knowledge to build custom alerts, either directly to the device 103 or more passively via for example an email.

In one aspect of the embodiment, context information that forms the background information that provides a broader understanding of the whole process, the device 103, its operation, or the events, as well as environmental changes surrounding the device 103 are correlated and stitched together at the external computer 115 with the sensor data (from the internal sensors 104 and external sensors 109) to create context-aware data for inference and root causing. For example, this data may be stitched together by an embodiment of the present disclosure primarily by timestamping the data as it is received, or back calculating the timestamp if the data is received in batches. This timestamp may then be used to determine what may have happened (for example where and when). These context-aware inferences generated at the external computer 115 may then be provided as an input to controllers and actuators to adapt to the context-aware data. This enables fine tuning and customized configuration of the device 103 taking the context and environment of the device 103 into consideration.

Further embodiments may allow ultra-low latency adaptive control, Fuzzy adaptive control, positive or negative feedback adaptive control, feed-forward adaptive control, fail operational adaptive control, self-adaptive tuning and control with or without contextual intelligence or environmental intelligence, Direct adaptive control, Indirect adaptive control, or Hybrid adaptive control.

In accordance with another embodiment, ultra-low latency time triggering may be used for data collection, machine learning inference cycle as well as for adaptive control. The time triggering may be independent for each step and optimized for efficiency.

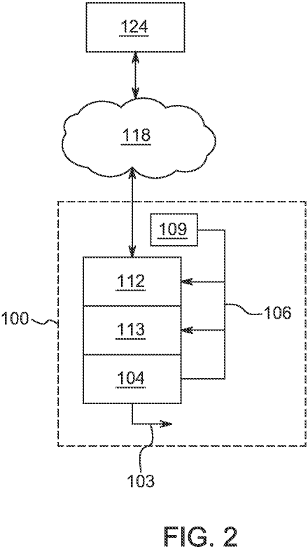

FIG. 2 illustrates an example machine learning based real-time self-adaptive tuning and control system at an edge location in accordance with the embodiments of the present disclosure. FIG. 2 will be explained in conjunction with description of FIG. 1.

In accordance with an embodiment of the present disclosure, executable instructions for data access from disparate data sources as well as executable instructions for inferencing at the edge at a low latency, which may be present at the separate external computer or processing system 115 may alternatively be deployed and executed on device’s internal computer or processing system 112. This is depicted in FIG. 2 of the present disclosure. More particularly, FIG. 2 illustrates another example machine learning based real-time self-adaptive tuning and control system at an edge location in accordance with the embodiments of the present disclosure.

In accordance with an embodiment of the present disclosure, computer instructions that execute on the external computer 115 may run on device’s internal computer 112, thus improving on the ultra-low latency for the machine learning and other inference and associated adaptive control. In accordance with another embodiment of the present disclosure, computer instructions that execute on the external computer 115 may run on the internal sensors 104 or the external sensors 109, thus taking adaptive control to an extreme edge where data is produced, which will even further reduce the latency in response.

FIG. 2 is similar to FIG. 1, except that the external computer 115 is omitted from FIG. 2 and the functionalities that execute on the external computer 115 may run on device’s internal computer 112, thereby improving on the ultra-low latency for the machine learning and the associated adaptive control. As such, the description corresponding to FIG. 1 is incorporated herein in its entirety.

In the illustrated example in FIG. 2, the device 103 is used in manufacturing, and has internal sensors 104 and external sensors 109 that sense and capture real-time data. The data store or the database 113 and device’s internal computer or processing system 112 capture context data. The primary controller on the device’s internal computer 112 may also communicate and capture data from its internal sensors 104 via any suitable communication network. The internal computer 112 may also communicate with the external sensors 109 via a suitable communication network 106, such as USB.

In accordance with an embodiment of the present disclosure, the internal computer 112 provides and transfers training data to a machine learning training platform on the remote computer 124 via the communication network 118 such as local area network (LAN). Remote computer 124 choses appropriate machine learning algorithm and trains the machine learning model. Computer instructions representing the trained model are then deployed on the internal computer 112 for local, at the edge inferencing. Real-time internal sensor data 104, external sensor data 109, context and logs data, as well as external environmental data is presented at time-triggered intervals or as the data comes into the machine learning runtime on the internal computer 112. Real-time inferencing is done using a proper trained machine learning model running on the internal computer 112 and results of the inferencing are used for alerts, or displaying normal behavior, or predicting an anomaly, or the results are validated for safe operations and improvements and used to actuate and set certain parameters on the device 103 via two-way communication network 106 with the primary controller on the internal computer 112. The primary controller on the internal computer 112 then actuates proper actuators on the device 103 and measures the Overall Equipment Effectiveness (OEE) improvements. The new value of sensor is then feedback to the internal computer 112 for validation of improvements, or further refinement of the parameter, which completes the control loop.

So, in accordance with the embodiments of the present disclosure, sensor data (from the internal sensors 104 and the external sensors 109), context data, environmental changes surrounding the device 103, changes in dynamics of the device 103, age and wear of device parts, structural damages, and changes in material, are all considered in real-time by the machine learning models running on the internal computer 112 to adjust operation parameters of the device 103 to improve the OEE.

In accordance with an embodiment of the present disclosure machine learning models running on the internal computer 112 and the adaptive control loop to activate the operation parameters after inference, are fed back in real-time over communication network 106 to the primary controller on the internal computer 112. The operation parameters are then actuated by the primary controller on the internal computer 112 using preferred protocol, and the resulting sensor data from the internal sensors 104 and external sensors 109 is fed back through the communication network 106 to the internal computer 112.

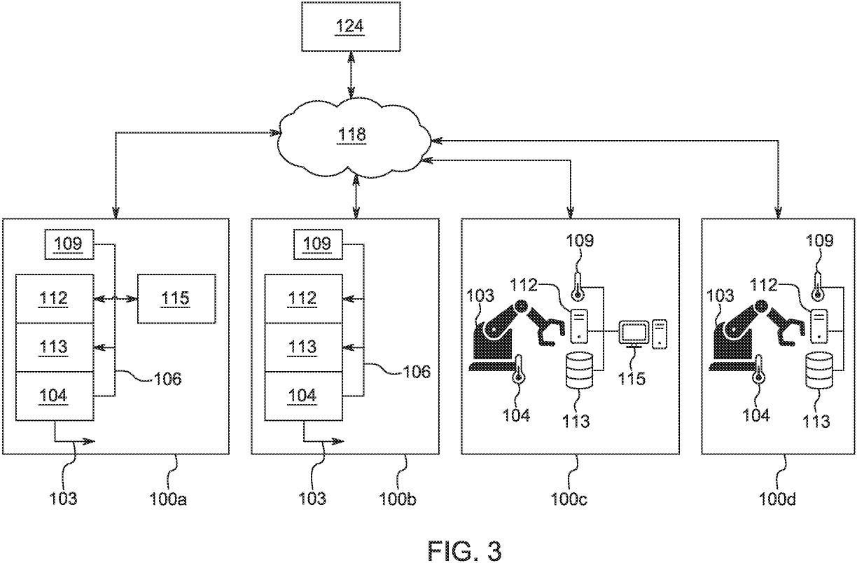

FIG. 3 illustrates yet another example machine learning based real-time self-adaptive tuning and control system at an edge location in accordance with the embodiments of the present disclosure. FIG. 3 will be explained in conjunction with descriptions of FIG. 1 and FIG. 2, and the descriptions corresponding to FIG. 1 and FIG. 2 are incorporated herein in its entirety.

FIG. 3 depicts a comprehensive view of machine learning based real-time self-adaptive tuning and control system for multiple edge devices 100a, 100b, 100c, and 100d in accordance with an embodiment of the present disclosure. In FIG. 3, the edge device 100a depicts the edge device 100 in accordance with the embodiment of FIG. 1, and the edge device 100b depicts the edge device 100 in accordance with the embodiment of FIG. 2. As such, the edge device 100 of FIG. 1 and the edge device 100 of FIG. 2 are reproduced as the edge device 100a and the edge device 100b, respectively, in FIG. 3.

The description of FIG. 1 and FIG. 2 with respect to the edge device 100 is incorporated herein in its entirety and thus further description of the edge device 100a and the edge device 100b may be omitted for brevity of this disclosure.

Further, in FIG. 3, another edge device 100c is depicted in accordance with an embodiment of FIG. 1 of the present disclosure. The edge device 100c is an illustrative view of the edge device 100 of FIG. 1 of the present disclosure. Similarly, a fourth edge device 100d is depicted in accordance with an embodiment of FIG. 2 of the present disclosure. The edge device 100d is an illustrative view of the edge device 100 of FIG. 2 of the present disclosure. Instead of the block view of the edge devices 100, as represented in FIG. 1 and FIG. 2, the edge devices 100c and 100d depict pictorial representations of various components of the edge device 100c and edge device 100d in FIG. 3. For example, FIG. 3 depicts the device 103 as a pictorial representation of a real-world device. Also, FIG. 3 depicts the internal sensors 104 and the external sensors 109 in a pictorial way to represent the real-world sensors. Similarly, FIG. 3 illustrates the internal computer 112, the external computer 115, the database 113, and the communication network 106 in a more pictorial way than FIG. 1.

In FIG. 3, the edge device 100c may represent an embodiment in accordance with FIG. 1 of the present disclosure and the edge device 100d may represent another embodiment in accordance with FIG. 2 of the present disclosure. The description of FIG. 1 and FIG. 2 with respect to the edge device 100 is incorporated herein in its entirety and thus further description of the edge device 100c and the edge device 100d may be omitted for brevity of this disclosure.

In FIG. 3, multiple edge devices 100a, 100b, 100c, and 100d are described, and machine learning based real-time self-adaptive tuning and control system is described for the multiple edge devices 100a, 100b, 100c, and 100d in accordance with an embodiment of the present disclosure. All the edge devices 100a, 100b, 100c, and 100d are connected to a remote computer or processing system 124 for training of a machine learning model. Communication between external computer 115 of edge devices 100a and 100c and remote computer 124 may be via communication network 118 such as local area network (LAN), a general wide area network (WAN), and/or a public network (e.g., the Internet, Wi-Fi, 5G) via network adapter etc. Remote computer 124 may be located on an on-prem location, remote to the edge site, or may be in a cloud. Communication between internal computer 112 of edge devices 100b and 100d and remote computer 124 may be via communication network 118.

In accordance with an embodiment of the present disclosure, the external computers 115 of the edge devices 100a and 100c, or the internal computers 112 of the edge devices 100b and 100d provide and transfer training data to a machine learning training platform on the remote computer 124 via communication network 118 such as local area network (LAN). Remote computer 124 choses appropriate machine learning model and trains the machine learning model. Computer instructions representing the trained machine learning model are then deployed on the external computers 115 of the edge devices 100a and 100c or on the internal computers 112 of the edge devices 100b and 100d for local, at the edge inferencing. Real-time internal sensor data 104, external sensor data 109, context and logs data, as well as external environmental data is presented at time-triggered intervals or as the data comes into the machine learning runtime on the external computers 115 of the edge devices 100a and 100c, or the internal computers 112 of the edge devices 100b and 100d. Real-time inferencing is done using the proper trained machine learning model running on the external computers 115 of the edge devices 100a and 100c, or the internal computers 112 of the edge devices 100b and 100d, and results of the inferencing are used for alerts, or displaying normal behavior, or predicting an anomaly, or the results are validated for safe operations and improvements and used to actuate and set certain parameters on the device 103 via two-way communication network 106 with the primary controller on the internal computer 112. The primary controller on the internal computer 112 then actuates proper actuators on the device 103 and measures the Overall Equipment Effectiveness (OEE) improvements. The new values of the sensors are then feedback to external computers 115 of the edge devices 100a and 100c, or the internal computers 112 of the edge devices 100b and 100d for validation of improvements, or further refinement of the parameter, which completes the control loop.

In accordance with an embodiment of the present disclosure, multiple components of device 103 are generally internal to a single machine. Examples of the different components may be controlling industrial PCs, motion controllers/PLCs, digital and/or analog sensors, actuators, cameras, etc. All of these components work together to achieve a unified goal - an example may be like a motion controller moving a robotic arm holding a part over a camera, while the camera takes a picture of the part. In this example, the robot arm and camera may be independent sub-components of the overall system, but both are integrated into a single machine to achieve a unified goal (in this example to take a picture of a part).

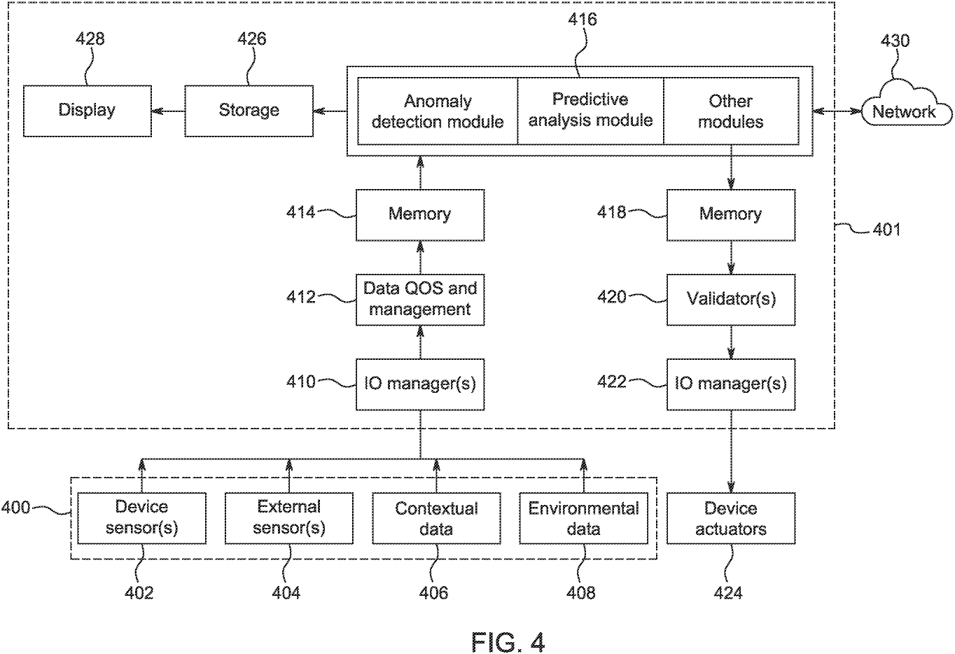

FIG. 4 depicts a schematic illustration of a real-time machine learning-based system for providing adaptive control of the device based on disparate input sources in accordance with an embodiment of the disclosure. FIG. 4 will be explained in conjunction with descriptions of FIG. 1 and FIG. 2, and the descriptions corresponding to FIG. 1 and FIG. 2 are incorporated herein in its entirety.

In accordance with an embodiment of the present disclosure, disparate input sources 400 may be any device based internal or external input sources that produce signals and measurements in real-time. Internal or device sensors 402 are sensors located internal to the device 103 (not shown in FIG. 4) that come with the device 103, which are physically attached to the device 103 and help with proper functioning of the device 103. Internal sensors 402 may be coupled to, or mounted on to the device 103, and may provide real-time measurements of the conditions of the device 103 or the process during operation. Internal sensors 402 can be for measuring motion, pressure, axis position, acceleration, rotation, tilt, temperature, vibrations, humidity, etc. Measurement of conditions on the device 103 may be supplemented with external sensors 404. These external sensors 404, such as Bosch XDK sensor, or machine vision cameras etc., measure motion, vibrations, acceleration, temperature, humidity, etc., or image data such as component cracks, placement, operator action, etc. The external sensors 404 may provide sensing of additional parameters that may be missed by the internal sensors 402. Contextual data 406 may be an additional data source. Contextual data 406 such as device functioning state, errors, testing data, parts inventory, age and wear on the parts, material details, preventive maintenance schedule, orders and delivery schedules, operator capabilities and other such data that forms the background information that provides a broader understanding of an event, person, device or component, and adds context to the sensor data (from the internal sensors 402 and the external sensors 404) and enables better intelligence. Environmental data 408 such as, environmental changes surrounding the device 103, such as a fan being on near the device 103, device 103 being close to a heat source, device 103 being close to a vibration source, humidity, etc.; changes in dynamics of the device 103, age and wear of device parts; structural damages, and changes in material, supplement all other data sources. All these disparate data sources may be taken into account to train and infer from various machine learning models running at the edge device 100 (of FIG. 1 and/or FIG. 2).

An edge compute engine 401, depicted in FIG. 4 may be an edge compute engine of the edge device 100, as depicted in FIG. 1 and/or FIG. 2 of the present disclosure. More particularly, the edge compute engine 401 may be a part of the device 103 (for example the edge compute engine 401 may be the internal computer 112) or may be external to the device 103 (for example the edge compute engine 401 may be the external computer 115). In an embodiment of the present disclosure, the edge compute engine 401 provides processing power for accessing disparate data sources 400, using machine learning computer instructions at the edge device 100 for inference, storage, display, processing real-time adaptive control instructions, and for executing instructions for feedback and actuation of controllers. Edge compute engine 401 constitutes one or more processors 416, employed to implement the machine learning algorithms, time triggering, anomaly detection, predictive analysis, root causing, adaptive control, etc. One or more processors 416 may comprise a hardware processor such as a central processing unit (CPU), a graphical processing unit (GPU), a general-purpose processing unit, or computing platform. One or more processors 416 may be comprised of any of a variety of suitable integrated circuits, microprocessors, logic devices and the like. Although the disclosure is described with reference to a processor, other types of integrated circuits and logic devices may also be applicable. The processor may have any suitable data operation capability. For example, the processor may perform 512 bit, 256 bit, 128 bit, 64 bit, 32 bit, or 16 bit data operations. One or more processors 416 may be single core or multi core processors, or a plurality of processors configured for parallel processing.

The one or more processors 416 may include different modules for example anomaly detection module to detect and alert about an abnormal event in the device 103 and a prediction analysis module for extracting information from data and using it to predict trends and behavior patterns. Similarly, the one or more processors 416 may include any other modules that may have any suitable data operation capability.

The one or more processors 416, or the automated manufacturing apparatus and control system itself, may be part of a larger computer system and/or may be operatively coupled to a computer network (a “network”) 430 with the aid of a communication interface to facilitate transmission of and sharing of data and predictive results. The computer network 430 may be a local area network, an intranet and/or extranet, an intranet and/or extranet that is in communication with the Internet, or the Internet. The computer network 430 in some cases is a telecommunication and/or a data network. The computer network 430 may include one or more computer servers, which in some cases enables distributed computing, such as cloud computing. The computer network 430, in some cases with the aid of a computer system, may implement a peer-to-peer network, which may enable devices coupled to the computer system to behave as a client or a server.

The edge compute engine 401 may also include memory 414 or memory locations (e.g., random-access memory, read-only memory, flash memory), electronic storage units (e.g., hard disks) 426, communication interfaces (e.g., network adapters) for communicating with one or more other systems, and peripheral devices, such as cache, other memory, data storage and/or electronic display adapters. The memory 414, storage units 426, interfaces and peripheral devices may be in communication with the one or more processors 416, e.g., a CPU, through a communication bus, e.g., as is found on a motherboard. The storage unit(s) 426 may be data storage unit(s) (or data repositories) for storing data.

The one or more processors 416, e.g., a CPU, execute a sequence of machine-readable instructions, which are embodied in a program (or software). The instructions are stored in a memory location. The instructions are directed to the CPU, which subsequently program or otherwise configure the CPU to implement the methods of the present disclosure. Examples of operations performed by the CPU include fetch, decode, execute, and write back. The CPU may be part of a circuit, such as an integrated circuit. One or more other components of the system may be included in the circuit. In some cases, the circuit is an application specific integrated circuit (ASIC).

The storage unit 426 stores files, such as drivers, libraries, and saved programs. The storage unit 426 stores user data, e.g., user-specified preferences and user-specified programs. The edge compute engine 401 in some cases may include one or more additional data storage units that are external to the edge compute engine 401, such as located on a remote server that is in communication with the edge compute engine 401 through an intranet or the Internet. The edge compute engine 401 may also have a display 428.

The edge compute engine 401 also comprises one or more IO Managers 410, and 422. IO Managers 410 and 422 are software instructions that may run on the one or more processors 416 and implement various communication protocols such as User Datagram Protocol (UDP), MODBUS, MQTT, OPC UA, SECS/GEM, Profinet, or any other protocol, to access data in real-time from disparate data sources 400. IO Managers 410 and 422 also enable two-way communication with controllers and actuators of the device 103 to send in commands and instructions for adaptive control. IO Managers 410 and 422 communicate with disparate data sources 400 directly via any communication network 430, such as Ethernet, Wi-Fi, Universal Serial Bus (USB), ZIGBEE, Cellular or 5G connectivity, etc., or indirectly through a device’s primary controller, through a Programmable Logic Controller (PLC) or through a Data Acquisition System (DAQ), or any other such mechanism.

Edge compute engine 401 also comprises a Data Quality of Service (QOS) and Data Management module 412 which is a set of computer instructions that run on the one or more processors 416. This Data Management module 412 ensures quality of data, for example, the Data Management module 412 may flag, or notify about missing data, and can quantify the performance of a data stream in real-time. For any machine learning algorithm, quality data is of utmost importance. The Data Management module 412 ensures quality of data input.

Edge compute engine 401 also comprises one or more validator modules 420. The one or more validator modules 420 are a set of computer instructions that run on the one or more processors 416. Proper validation may be done on the inferenced parameters by the one or more validator modules 420 before setting them on the controller of the device 103 to make sure desired improvements may be achieved, device parts or process may not be affected, the values of operation parameters may remain within proper thresholds and tracked matrix may show improvements. The one or more validator modules 420 ensure improvements in device uptime, UPH, Yield, cost of operation, spare parts usage, cycle time improvements and Overall Equipment Effectiveness (OEE) improvements for all adaptive control actions.

In accordance with one embodiment, device sensor data from the internal sensors 402, such as motion, axis position, acceleration, rotation, tilt, temperature, vibrations, humidity, etc.; external sensor data that supplements the device sensor data and is collected by installing external sensors 404 on the device 103; image data such as component cracks, placement, operator action, etc.; context data 406, such as the device 103 functioning state, errors, testing data, parts inventory, age and wear on the parts, material details, preventive maintenance schedule, orders and delivery schedules, operator capabilities and other such data that forms the background information that provides a broader understanding of an event, person, or component; and environmental data 408 such as changes surrounding the device 103, such as a fan being on near the device 103, the device 103 being close to a heat source, the device 103 being close to a vibration source, humidity, etc.; changes in dynamics of the device 103, age and wear of device parts; structural damages, and changes in material, all these disparate data sources 400 are accessed in real-time either through an event based mechanism, such as a pub-sub mechanism where any sensor or state change is notified to the listeners, or through a ultra-low latency time triggered mechanism where correlated data is fetched at periodic time triggers, optimized to fetch data as it changes. The data is fetched in real-time by the IO Managers 410 and 422 through various protocols, such as UDP from disparate data sources 400. Data QOS and management module 412 performs data QOS on input data and any missing data may be flagged. Data or features in desired state are then presented in memory to the one or more processors 416 that hosts the trained machine learning models.

Computer instruction sets and algorithms for time triggering, learning, anomaly detection, predictive analysis, root causing as well as adaptive control are executed on the one or more processors 416 with input from memory 414. Network 430 may be used to transfer data for training to a remote computer 124 (as shown in FIG. 1). Network 430 may also be used to deploy trained machine learning models and associated computer instruction sets on to the one or more processors 416. The machine learning model training may happen at the edge device 100 on the one or more processors 416 (as per the embodiment of the present disclosure depicted in FIG. 2), close to the data source, in the cloud, or on any remote computer.

In an embodiment of the present disclosure, data from disparate input sources 400 is fed in memory 414 and then to a machine learning runtime engine running on the one or more processors 416 close to the disparate input sources 400 in order to get low latency inferencing. In certain embodiments, inferencing from machine learning models happens in real-time at ultra-low frequency of 5 to 30 ms. Machine learning inferences, results and predictions are also stored in memory 418 for faster access. In certain embodiments, the inferences and results from machine learning algorithms are validated in one or more validation modules 420 for proper behavior and improvements. Further, feedback is sent to the controller of the device 103 through the IO Manager 422, for example through a UDP IO Manager. The control variables are then transported over communication network 430, such as USB, directly or indirectly through a primary controller or DAQ or a PLC for actuation to device actuators 424. The controller of the device 103 actuates the desired parameters and results of the changes are fed to the run-time engine or a particular module of the one or more processors 416 to validate improvements or do further changes. This helps to achieve improvements in device uptime, UPH, Yield, cost of operation, spare parts usage, cycle time improvements and Overall Equipment Effectiveness (OEE) improvements. In parallel to the adaptive control loop, data and results may be stored in the storage unit 426, such as a database and displayed on a display 428 via a user interface.

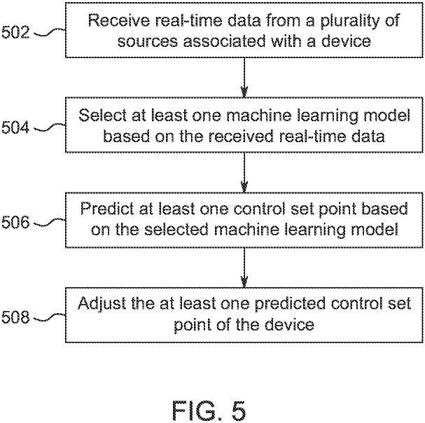

FIG. 5 illustrates a flowchart for real-time self-adaptive tuning and control of a device using machine learning in accordance with an embodiment of the disclosure. In particular, the flowchart of FIG. 5 describes a method for real-time self-adaptive tuning and control of a device 103 using machine learning. The method, at step 502, describes that real-time data for a plurality of parameters of the device 103 is received (by the external computer 115 as described in the embodiment of FIG. 1 or is received by the internal computer 112 as described in the embodiment of FIG. 2) from a plurality of sources 400 associated with the device 103. At step 504, the method describes that at least one machine learning model from a plurality of machine learning models is selected (by the external computer 115 as described in the embodiment of FIG. 1 or by the internal computer 112 as described in the embodiment of FIG. 2) based on the received real-time data. Further, the flowchart of FIG. 5, at step 506, describes that at least one control set point is predicted (by the external computer 115 as described in the embodiment of FIG. 1 or by the internal computer 112 as described in the embodiment of FIG. 2) based on the at least one selected machine learning model. The at least one predicted control set point of the device 103 is adjusted for the real-time self-adaptive tuning and control of the device 103 at step 508 depicted in the flowchart of FIG. 5.

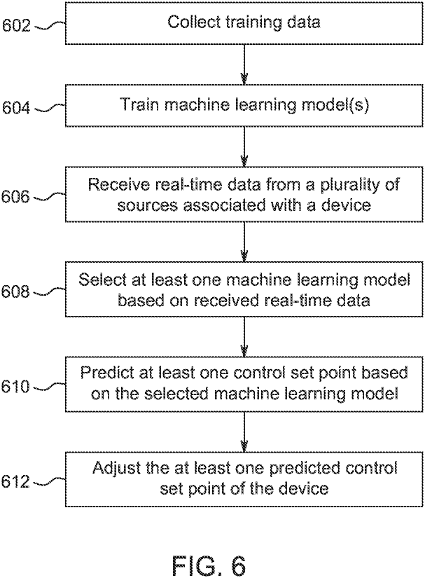

FIG. 6 illustrates a flowchart for training a machine learning model for real-time self-adaptive tuning and control of a device using the machine learning model in accordance with an embodiment of the disclosure.

The flowchart of FIG. 6 describes a method for real-time self-adaptive tuning and control of a device 103 using machine learning. The method, at step 602, describes that training data for at least one of the plurality of parameters of the device 103 is collected by at least one of the plurality of sources 400 associated with the device 103. At step 604, the method described by the flowchart of FIG. 6, describes that at least one machine learning model from a plurality of machine learning models is trained by the remote computer 124 based on the collected training data.

Further, the flowchart of FIG. 6, at step 606, describes that real-time data for a plurality of parameters of the device 103 is received (by the external computer 115 as described in the embodiment of FIG. 1 or is received by the internal computer 112 as described in the embodiment of FIG. 2) from the plurality of sources 400 associated with the device 103. At step 608, the method describes that at least one machine learning model from a plurality of machine learning models is selected (by the external computer 115 as described in the embodiment of FIG. 1 or by the internal computer 112 as described in the embodiment of FIG. 2) based on the received real-time data. Further, the flowchart of FIG. 6, at step 610 describes that at least one control set point is predicted (by the external computer 115 as described in the embodiment of FIG. 1 or by the internal computer 112 as described in the embodiment of FIG. 2) based on the at least one selected machine learning model. The at least one predicted control set point of the device 103 is adjusted for the real-time self-adaptive tuning and control of the device 103 at step 612 of the flowchart of FIG. 6.

The advantage of the disclosed solution is that the external computer 115 uses the needed sensor and context data from internal memory, so that there is no lag or time wasted in making a database or any other TCP connection. This is critical for ultra-low latency inferencing. Self-tuning and self-adaptive correction of the device 103 is also enabled. The present disclosure also enables localized tuning of the device 103 as the algorithm and settings may be specific for each device while considering environmental changes, specific changes in dynamics of individual device, wear and tear and life of the parts, as well as any structural defects in the individual device.

In accordance with the embodiments of the present disclosure, sensor data (from the internal sensors 104 and the external sensors 109), context data, environmental changes surrounding the device 103, changes in dynamics of the device 103, age and wear of device parts, structural damages, and changes in material, are all considered in real-time by the machine learning models running on the external computer 115 to adjust operation parameters of the device 103 to improve the OEE.

In accordance with an embodiment of the present disclosure machine learning models running on the external computer 115 and the adaptive control loop to activate the operation parameters after inference, are fed back in real-time over communication network 106 to primary controller on the internal computer 112. The operation parameters are then actuated by the primary controller on the internal computer 112 using preferred protocol and the resulting sensor data from the internal sensors 104 and the external sensors 109 is fed back through communication network 106 to the external computer or processing system 115. The machine learning models running on the external computer 115 may then further be corrected to achieve the target state.

In an embodiment of the present disclosure, adaptive control machine learning models running on the external computer 115 may be used to self-calibrate and self-tune the device 103 continuously to get most optimal performance from the device 103. Calibration of the device 103 and device’s internal sensors 104 is important to ensure accurate measurements, product quality, safety, profitability, complying with regulations, return on investment, reduction in production errors and recalls, and extending life of the device 103.

The disclosed methods may be performed by processing logic that may include hardware (circuitry, dedicated logic, etc.), software (such as run on a general-purpose computer system or a dedicated machine), or a combination of both. The processing logic may be included in any node or device (e.g., edge device 100, device 103 etc.), or any other computing system or device. A person with ordinary skill in the art will appreciate that the disclosed method is capable of being stored on an article of manufacture, such as a non-transitory computer-readable medium. In an embodiment, the article of manufacture may encompass a computer program accessible from a storage media or any computer-readable device.

In accordance with the embodiments of this disclosure, a method is disclosed. The method includes receiving real-time data for a plurality of parameters of the device from a plurality of sources associated with the device and selecting at least one machine learning model from a plurality of machine learning models based on the received real-time data. The method further includes predicting at least one control set point based on the at least one selected machine learning model. The at least one predicted control set point of the device is adjusted for the real-time self-adaptive tuning and control of the device.

In accordance with the embodiments of this disclosure, the method further comprises collecting training data for at least one of the plurality of parameters of the device from at least one of the plurality of sources associated with the device and training the at least one machine learning model from the plurality of machine learning models based on the collected training data.

In accordance with the embodiments of this disclosure, the real-time data comprises one or more of sensor data from at least one sensor located inside the device, sensor data from at least one sensor located outside the device, context data, changes in dynamics of the device, and environmental data surrounding the device.

In accordance with the embodiments of this disclosure, the context data comprises one or more of functioning state, device functioning errors, inventory status, device parts log, wear and tear status, material details, preventive maintenance schedule, order status, delivery schedules, degraded device state, and operator parameters.

In accordance with the embodiments of this disclosure, an anomaly detection module is being used for detecting an abnormal event in the device and a predictive analysis module is being used for predicting a potential failure of the device. Further, the anomaly detection module and the predictive analysis module are based on at least one of the selected machine learning models.

In accordance with the embodiments of this disclosure, the anomaly detection module and the predictive analysis module are being used for the real-time self-adaptive tuning and control of the device.

In accordance with the embodiments of this disclosure, adjusting the at least one predicted control set point of the device includes one or more of: operating the device in a first state, where the first state is a self-stopping state of the device, and operating the device in a second state, where the second state is a slowing down state of the device.

In accordance with the embodiments of this disclosure, training the at least one machine learning model comprises training the at least one machine learning model at an edge of the device, wherein the edge of the device corresponds to one or more of: close to a source of the plurality of sources of the device, a cloud, and a remote computer.

In accordance with the embodiments of this disclosure, receiving the real-time data comprises correlating and stitching together one or more of sensor data, from one or more of sensor located inside the device, sensor located outside the device, context data, changes in dynamics of the device, and environmental data surrounding the device, to form context-aware data.

In accordance with the embodiments of this disclosure, selecting the at least one machine learning model comprises selecting the at least one machine learning model based at least on the context-aware data.

In accordance with the embodiments of this disclosure, adjusting the at least one predicted control set point of the device comprises automatically adjusting the at least one predicted control set point.

In accordance with the embodiments of this disclosure, the method further comprises providing root cause analysis and instructions on out-of-control action plans (OCAPs) to an operator on detecting the abnormal event.

In accordance with the embodiments of this disclosure a system for real-time self-adaptive tuning and control of a device using machine learning is disclosed. The system comprises a computing device configured to receive real-time data for a plurality of parameters of the device from a plurality of sources associated with the device and select at least one machine learning model from a plurality of machine learning models based on the received real-time data. The computing device of the system according to the present embodiment of the disclosure is further configured to predict at least one control set point based on the at least one selected machine learning model. The at least one predicted control set point of the device is adjusted for the real-time self-adaptive tuning and control of the device.

In accordance with the embodiments of this disclosure, the computing device in the system described by the embodiment of this disclosure is configured to collect training data for at least one of the plurality of parameters of the device from at least one of the plurality of sources associated with the device.

In accordance with the embodiments of this disclosure, the system further comprises a remote computing device located remotely from the device and connected to the device via a communication network. The remote computing device is configured to train the at least one machine learning model from the plurality of machine learning models based on the collected training data.

The terms “comprising,” “including,” and “having,” as used in the claim and specification herein, shall be considered as indicating an open group that may include other elements not specified. The terms “a,” “an,” and the singular forms of words shall be taken to include the plural form of the same words, such that the terms mean that one or more of something is provided. The term “one” or “single” may be used to indicate that one and only one of something is intended. Similarly, other specific integer values, such as “two,” may be used when a specific number of things is intended. The terms “preferably,” “preferred,” “prefer,” “optionally,” “may,” and similar terms are used to indicate that an item, condition, or step being referred to is an optional (not required) feature of the invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described to best explain the principles of the invention and the practical application, and to enable others of ordinary skill in the art to understand the invention for various embodiments with various modifications as are suited to the particular use contemplated.

The present disclosure has been described with reference to various specific and preferred embodiments and techniques. However, it should be understood that many variations and modifications may be made while remaining within the spirit and scope of the invention. It will be apparent to one of ordinary skill in the art that methods, devices, device elements, materials, procedures, and techniques other than those specifically described herein can be applied to the practice of the invention as broadly disclosed herein without resort to undue experimentation. All art-known functional equivalents of methods, devices, device elements, materials, procedures, and techniques described herein are intended to be encompassed by this invention. Whenever a range is disclosed, all subranges and individual values are intended to be encompassed. This invention is not to be limited by the embodiments disclosed, including any shown in the drawings or exemplified in the specification, which are given by way of example and not of limitation. Additionally, it should be understood that the various embodiments of the SP network architecture described herein contain optional features that can be individually or together applied to any other embodiment shown or contemplated here to be mixed and matched with the features of that architecture.

While the invention has been described with respect to a limited number of embodiments, those skilled in the art, having benefit of this disclosure, will appreciate that other embodiments can be devised which do not depart from the scope of the invention as disclosed herein.

I/We claim:

1. A method for real-time self-adaptive tuning and control of a device using machine learning, the method comprising:
receiving real-time data for a plurality of parameters of the device from a plurality of sources associated with the device;
selecting at least one machine learning model from a plurality of machine learning models based on the received real-time data;
predicting at least one control set point based on the at least one selected machine learning model, wherein the at least one predicted control set point of the device is adjusted for the real-time self-adaptive tuning and control of the device.

2. The method of claim 1, further comprising:
collecting training data for at least one of the plurality of parameters of the device from at least one of the plurality of sources associated with the device; and
training the at least one machine learning model from the plurality of machine learning models based on the collected training data.

3. The method of claim 2, wherein training the at least one machine learning model comprises training the at least one machine learning model at an edge of the device, wherein the edge of the device corresponds to one or more of: close to a source of the plurality of sources of the device, a cloud, and a remote computer.

4. The method of claim 1, wherein the real-time data comprises one or more of sensor data from at least one sensor located inside the device, sensor data from at least one sensor located outside the device, context data, changes in dynamics of the device, and environmental data surrounding the device.

5. The method of claim 4, wherein the context data comprises one or more of functioning state, device functioning errors, inventory status, device parts log, wear and tear status, material details, preventive maintenance schedule, order status, delivery schedules, degraded device state, and operator parameters.

6. The method of claim 1, wherein an anomaly detection module is being used for detecting an abnormal event in the device and a predictive analysis module is being used for predicting a potential failure of the device, and wherein the anomaly detection module and the predictive analysis module are based on at least one of the selected machine learning model.

7. The method of claim 6, wherein the anomaly detection module and the predictive analysis module are being used for the real-time self-adaptive tuning and control of the device.

8. The method of claim 6, further comprising:
providing root cause analysis and instructions on out-of-control action plans (OCAPs) to an operator on detecting the abnormal event.

9. The method of claim 1, wherein adjusting the at least one predicted control set point of the device includes one or more of:
operating the device in a first state, wherein the first state is a self-stopping state of the device; and
operating the device in a second state, wherein the second state is a slowing down state of the device.

10. The method of claim 1, wherein receiving the real-time data comprises:
correlating and stitching together one or more of sensor data, from one or more of sensor located inside the device, sensor located outside the device, context data, changes in dynamics of the device, and environmental data surrounding the device, to form context-aware data.

11. The method of claim 10, wherein selecting the at least one machine learning model comprises selecting the at least one machine learning model based at least on the context-aware data.

12. The method of claim 1, wherein adjusting the at least one predicted control set point of the device comprises automatically adjusting the at least one predicted control set point.

13. A system for real-time self-adaptive tuning and control of a device using machine learning, the system comprising:
a computing device configured to:
receive real-time data for a plurality of parameters of the device from a plurality of sources associated with the device;
select at least one machine learning model from a plurality of machine learning models based on the received real-time data;
predict at least one control set point based on the at least one selected machine learning model, wherein the at least one predicted control set point of the device is adjusted for the real-time self-adaptive tuning and control of the device.

14. The system of claim 13, wherein the computing device is further configured to collect training data for at least one of the plurality of parameters of the device from at least one of the plurality of sources associated with the device.

15. The system of claim 13, further comprising:
a remote computing device located remotely from the device and connected to the device via a communication network, wherein the remote computing device is configured to train the at least one machine learning model from the plurality of machine learning models based on the collected training data.

16. The system of claim 15, wherein the remote computing device is further configured to train the at least one machine learning model at an edge of the device, wherein the edge of the device corresponds to one or more of: close to a source of the plurality of sources of the device, a cloud, and a remote computer.

17. The system of claim 13, wherein the real-time data comprises one or more of sensor data from at least one sensor located inside the device, sensor data from at least one sensor located outside the device, context data, changes in dynamics of the device, and environmental data surrounding the device.

18. The system of claim 17, wherein the context data comprises one or more of functioning state, device functioning errors, inventory status, device parts log, wear and tear status, material details, preventive maintenance schedule, order status, delivery schedules, degraded device state, and operator parameters.

19. The system of claim 13, wherein the computing device is further configured to correlate and stitch together one or more of sensor data, from one or more of sensor located inside the device, sensor located outside the device, context data, changes in dynamics of the device, and environmental data surrounding the device, to form context-aware data.

20. The system of claim 19, wherein the computing device is further configured to select the at least one machine learning model based at least on the context-aware data.
